(19) United States
(12) Patent Application Publication
(10) Pub. No.: US 2011/0087616 A1
(43) Pub. Date: Apr. 14, 2011

(54) SYSTEM AND METHOD FOR CREATING A GRAPHICAL REPRESENTATION OF PORTFOLIO RISK

(75) Inventors: Hovey Raymond Strong, JR., San Jose, CA (US); Sekou Remy, San Jose, CA (US); Tobin Jon Lehman, San Jose, CA (US)

(73) Assignee: International Business Machines Corporation, Armonk, NY (US)

(21) Appl. No.: 12/576,956

(22) Filed: Oct. 9, 2009

(51) Int. Cl. G06Q 40/00; G06T 11/20

(52) U.S. Cl. 705/36 R; 345/440

(57) ABSTRACT

A method for displaying portfolio risk is described. The method includes receiving a time series corresponding to a weight and a desirability of each of an asset in a portfolio. The method further includes maintaining the time series corresponding to the weight and the desirability of each of the assets in the portfolio. The method also includes maintaining a standard time series for comparison with the time series corresponding to the weight and the desirability of each of the assets in the portfolio. The method further includes displaying, for each asset in the portfolio, a quantity based on desirability versus a quantity based on the correlation between desirability and the standard time series over two specified windows of time. The method also includes displaying trend information based on moving two specified windows of time from the past to the point where at least one window is the most current window.

### FIELD OF THE INVENTION

Embodiments of the disclosure relate generally to the field of displaying graphical information. For example, embodiments of the disclosure relate to systems, methods and computer programs for creating a graphical representation of portfolio risk.

### BACKGROUND

Modern Portfolio Management Theory proposes that rational investors will use diversification to optimize a portfolio. Similarly, arbitrage-pricing theory proposes that an asset that is over or under valued from its expected price will correct. However, both theories are limited because they assume static distributions rather than assets whose behavior has an immediate random element but also a correlation (with the behavior of other assets) that changes (sometimes dramatically) over time.

Modern Portfolio Management decisions are also generally related to making small and gradual changes, rather than creating or terminating assets.

### SUMMARY

A system and method for displaying portfolio risk is described. The method for displaying portfolio risk includes receiving a time series corresponding to a weight and a desirability of each of an asset in a portfolio. The method further includes maintaining the time series corresponding to the weight and the desirability of each of the assets in the portfolio. The method also includes maintaining a standard time series for comparison with the time series corresponding to the weight and the desirability of each of the assets in the portfolio. The method further includes displaying, for each asset in the portfolio, a quantity based on desirability versus a quantity based on the correlation between desirability and the standard time series over two specified windows of time. The method also includes displaying trend information based on moving two specified windows of time from the past to the point where at least one window is the most current window.

This illustrative embodiment is mentioned not to limit or define the invention, but to provide examples to aid understanding thereof. Illustrative embodiments are discussed in the Detailed Description, and further description of the disclosure is provided there. Advantages offered by various embodiments of this disclosure may be further understood by examining this specification.

### BRIEF DESCRIPTION OF THE DRAWINGS

These and other features, aspects, and advantages of the present invention are better understood when the following Detailed Description is read with reference to the accompanying drawings, wherein:

FIGS. 1A and 1B are block diagram representations illustrating a method of determining the correlation of the desirability of each of an asset a in a portfolio and a weighted average normalized desirability P of the portfolio over a specified time, and also determining the diversification of the desirability of portfolio assets, the trend of desirability of each asset, and the trend of the above mentioned correlation of each asset.

FIG. 2A is a scatter plot showing the relation of desirability D of an asset with the correlation C of that asset to the weighted average normalized desirability P of the portfolio of assets at a specific time.

FIG. 2B is a scatter plot showing the relation of desirability D of an asset with the correlation C of that asset to the weighted average normalized desirability of the portfolio of assets as D and C change over time.

FIG. 2C is a superposition of trend information on the scatter plot of FIG. 2A. Each arrow represents the trend of an asset in the two dimensions desirability D and correlation C. The length of the arrow represents the strength of the trend.

FIG. 3A is an example of computer architecture for implementing the embodiments as illustrated in FIGS. 1-2.

FIG. 3B is a block diagram of the overall system architecture for implementing the embodiments seen in FIGS. 1-2.

### DETAILED DESCRIPTION OF PREFERRED EMBODIMENTS

Embodiments of the disclosure relate generally to the field of displaying graphical information. For example, embodiments of the disclosure relate to systems, methods and computer programs for creating a graphical representation of portfolio risk.

Throughout the description, for the purposes of explanation, numerous specific details are set forth in order to provide a thorough understanding of the present disclosure. It will be apparent, however, to one skilled in the art that the present disclosure may be practiced without some of these specific details. In some instances, well-known structures and devices are shown in diagram form to avoid obscuring the underlying principles of the present disclosure.

The following mathematical preliminary definitions are assumed throughout: When V is a vector, let m(V) be the average of the elements of V; let ∥V∥ be the square root of the sum of the squares of the elements of V; let M(V) be the result of replacing each element v of V by (v−m(V)); let N(V) be the result of replacing each element u of M(V) by u/∥M(V)∥; and when U and V are vectors of the same shape, let R(U,V)=the inner product N(U)*N(V) of vectors N(U) and N(V). R(U,V) is the correlation between vector U and vector V and we call N(V) the normalization of V.

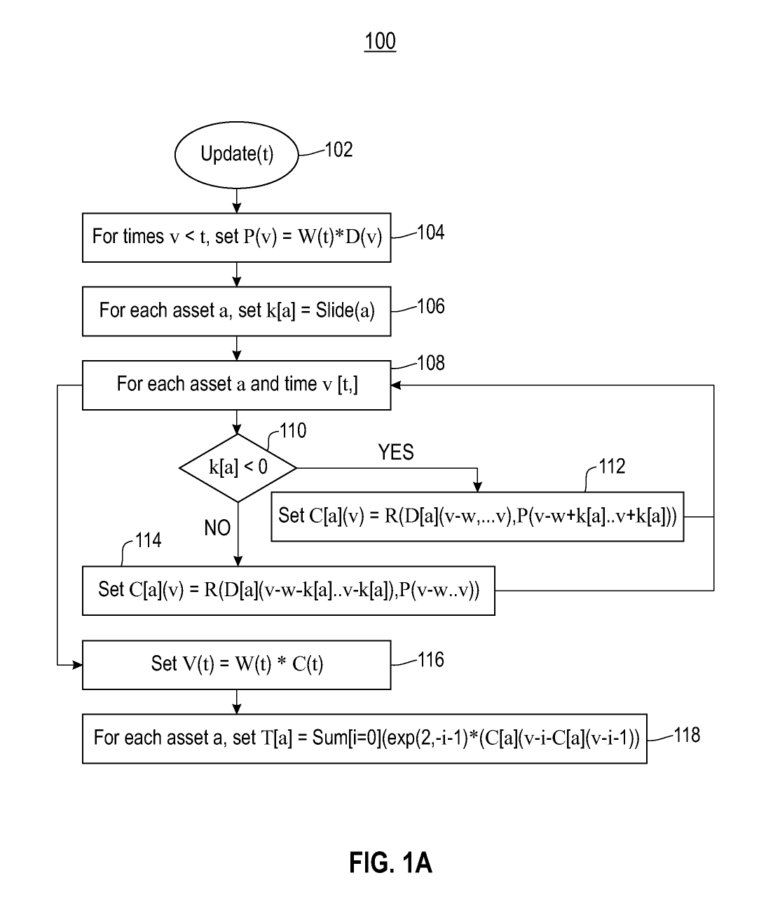

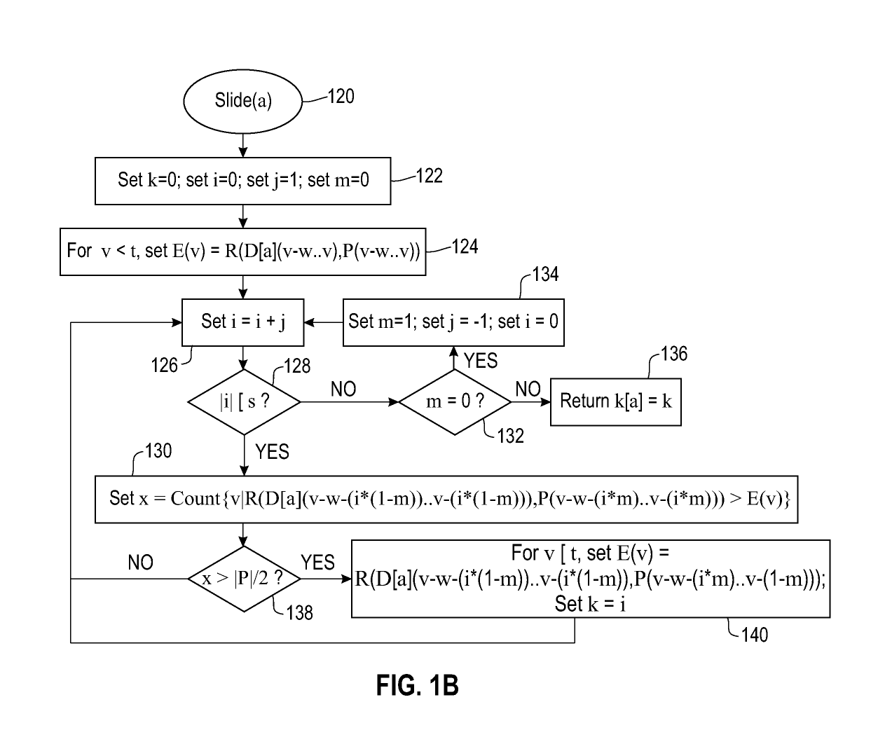

FIGS. 1A and 1B are block diagrams 100, which shows an example method of determining the correlation between the desirability D of an asset a and a weighted average normalized desirability P over a specified time and also determining diversification and the trend of desirability and the trend of correlation for each asset. Desirability is viewed as a quantitative measure over which the user of the display has no control. The normalized weight is viewed as independent of the desirability and typically under some control by the user of the display. An advantage of this invention is to provide the display user with information useful in making choices about altering the normalized weights of the assets in the portfolio.

Initially, it is desirable to maintain two time series for each asset, referred to as W[a](t) and D[a](t). D[a](t) refers to the desirability of a given asset a at a given time t. W[a](t) refers to the normalized weight of a given asset a at a given time t. In this context, normalized weight W refers to the fraction of the total portfolio represented by the value or quantity of the asset. D[a](t) refers to the desirability of a given asset a at a given time t. Various factors may be used to determine variability: for example, productivity or estimated benefit minus estimated cost. However, other factors could be used to determine desirability.

Window size w and slide maximum s parameters are selected as to satisfy Expression 1. These parameters are selected in order to study changes in the relative behavior of portfolio assets over time. The parameter w represents a number of time periods large enough to smooth out random fluctuations but small enough to capture changes in long term trend. Typical choices of w range from 6 periods to 12 periods (where a period is typically a month). Parameter s is selected to detect a hidden correlation between two time series representing the desirability of two distinct assets when the behavior of one asset follows the other by a delay. Typical selections for s are either 0 (no detection of delayed correlation) or 1 (detection of correlation delayed by one period).

|D[a]|≧2w+s+1 [Expression 1]

Referring now to FIG. 1A, it can be seen that in one embodiment that information is updated from the last time t in the time series at 102. Proceeding to 104, it can be seen that in one embodiment the Weighted average normalized desirability P(v) is computed as seen in Expression 2.

For times v<t,set P(v)=W(t)*N(D(v)), [Expression 2]

Expressed in alternatively, for times v<t, set P(v)=W(t)*N(D(v)), where * represents the inner or dot product of two vectors, W(t) being the vector of weights for assets in the portfolio, D(v) being the vector of desirabilities of assets in the portfolio at time v, and N being the normalization function for vectors. The weights used are the current weights (time t), not the weights at past time v.

Proceeding to 106, it can be seen in one embodiment that Slide(a) is determined and that for each asset a, k[a] is set to equal Slide(a). Slide(a) represents the result of detecting whether there is a hidden (delayed) correlation between the desirability of asset a and the weighted average portfolio desirability P. If there is no delayed correlation, or if its detection is not attempted, then Slide(a) will be 0. If asset a follows the behavior of P delayed by one period then the Slide(a) will be 1. If asset a leads the behavior of P by one period then Slide(a) will be −1.

In block 106, for each asset a, set k[a]=Slide(a). Slide (a)/k[a] refers to the amount by which we slide our window for asset a over the window for the portfolio weighted average P. Phrased differently, k[a] is a measure of the delay or advance of the correlation between asset a and the portfolio weighted average P.

Proceeding to 108, it can be seen in one embodiment that decision block 108 determines whether all assets a and times v<t have been considered. If this condition has occurred, one proceeds to block 116 where V(t) is set as set forth in Expression 3.

V(t)=W(t)*C(t) [Expression 3]

At 108, if some asset a or time v<t, has not been considered, in one embodiment, one proceeds to decision block 110 to determine if k[a]<0. If yes, proceed to block 112. If no, proceed to 114.

In one embodiment, it can been seen that C[a](v) is set using [Expression 4] in block 112.

Set C[a](v)=R(D[a](v−w, . . . v),P(v−w+k[a] . . . v+k[a])), [Expression 4]

where R computes the correlation coefficient between the two vectors D[a](v−w, . . . , v) and P(v−w+k[a], . . . , v+k[a]).

In one embodiment of block 114 it can been C[a](v) is calculated using [Expression 5].

C[a](v)=R(D[a](v−w−k[a] . . . v−k[a]),P(v−w . . . v)), [Expression 5]

where R is as in Expression 5.

Proceeding from block 116 to 118, for each asset a, the trend of asset a T[a] is calculated as an exponential average of pairs, each pair consisting of a difference in correlation and a difference in desirability, as set forth in [Expression 6].

T[a]=Sum[i=0](exp(2,−i−1)<C[a](v−i)−C[a](v−i−1),D[a](v−i)−D[a](v−i−1)) [Expression 6]

At Block 120, seen in FIG. 1B, Slide(a) is called. It should be noted that in one embodiment, when s=0, it follows that k[a]=0, so the call to Slide(a) can be skipped. The values k[a], for each asset a, determined in Blocks 120-140 are used in FIG. 1A at Block 106.

Proceeding to 122, k, i, j and m are set to zero. In this block diagram, m and j represent the mode: when the mode is positive, m=0, j=1, and the search begins with i=1 and searches over increasing i; when the mode is negative, m=1, j=−1, and the search begins with i=−1 and searches over decreasing i.

Proceeding to 124, for v[t], set E(v) is set as in [Expression 7].

E(v)=R(D[a](v−w . . . v),P(v−w . . . v)) [Expression 7]

Proceeding to 126, i is incremented by j as in [Expression 8]

[i=i+j] [Expression 8]

Decision block 128, tests whether the absolute value of i is less than or equal to s, in which case the search continues in the same mode.

If yes, proceed to block 130, where in one embodiment, Set x as set forth in [Expression 9].

x=Count{v|R(D[a](v−w−(i*(1−m)) . . . v−(i*(1−m))),P(v−w−(i*m) . . . v−(i*m)))>E(v)}] [Expression 9]

If the result of decision block 128 is negative, proceed to decision block 132. If m=0, proceed to 134 and set m=1, set j=−1 and set i=0; otherwise return k. where k is the value of Slide(a) in block 106 of FIG. 1A.

After setting x in block 130, proceed to block 138 and determine if x exceeds half the length of time series P. If no, proceed to 126; if yes, proceed to 140 where, for v<t, set E(v) as set forth in [Expression 10].

For v<t,set E(v)=R(D[a](v−w−(i*(1−m)) . . . v−(i*(1−m)),P(v−w−(i*m) . . . v−(1m)));set k=i. [Expression 10]

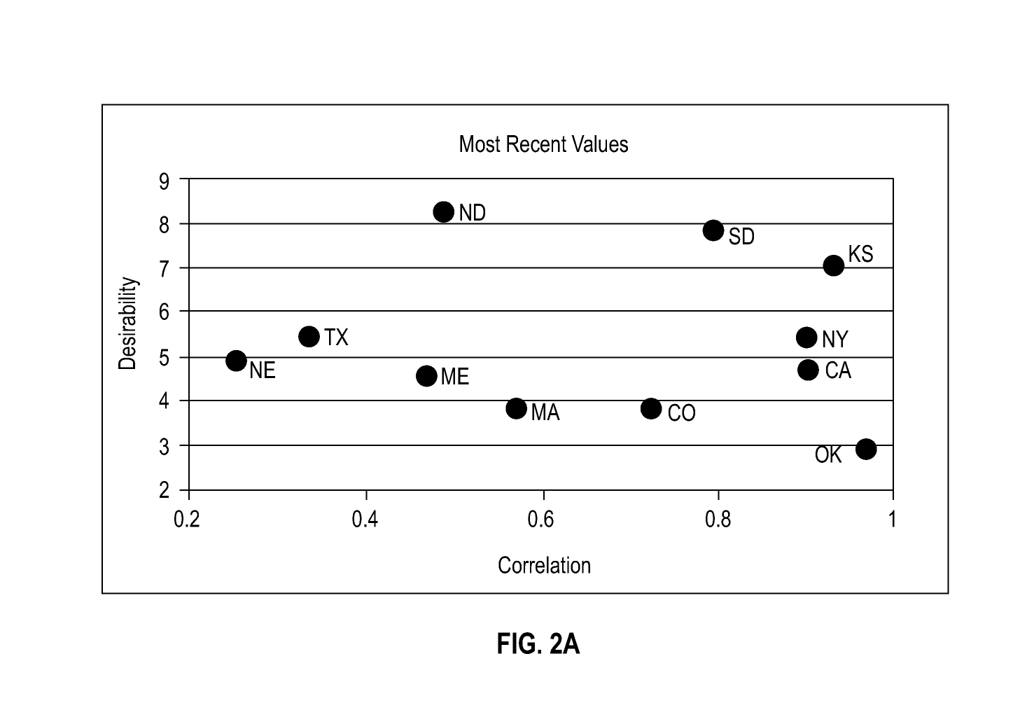

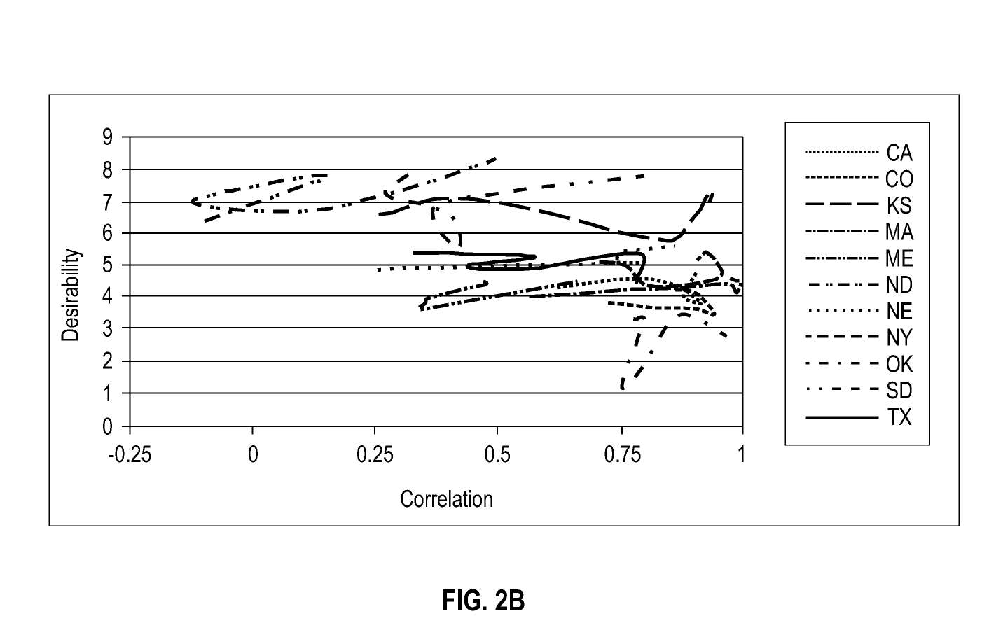

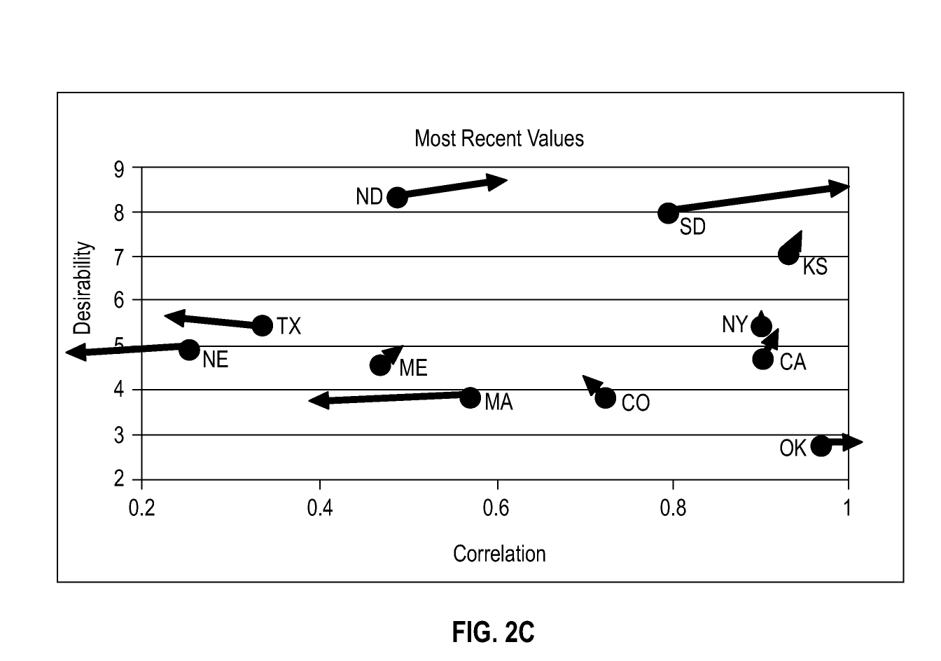

FIG. 2A shows a graphical representation, in the form of a scatter plot, of Desirability D versus Portfolio Weighted average normalized desirability P. This can also be expressed as D(t) v. C(t). In FIG. 2C, T(t) is also shown as a vector for each asset a. The vertical axis of FIG. 2A shows the desirability of an asset a and the horizontal axis shows the correlation between the asset of interest and the weighted average of all the assets. In FIG. 2A, one can view the desirability of locating a facility in a particular state. For example, FIG. 2A displays a graphical representation of the desirability of several states. The collection of states with facilities may be thought of as a portfolio of assets. Alternatively, the states seen in FIG. 2A could represent any assets. Examples of an asset a could be a stock, a bond, a project, a line of business, a production center, a service delivery center, a distribution center, or others discussed below.

It should be noted that the direction and length of the arrow indicate the trend T over the time period of interest. Thus, FIG. 2C shows that the correlation of Texas and Oklahoma's desirability overall weighted average normalized desirability of all assets a under consideration is increasing. However, Texas continues to be a more desirable asset than Oklahoma. FIG. 2C also shows that the desirability of Massachusetts and also its correlation have slightly decreased.

The present system, method and computer program could be used to evaluate any kind of asset for which there is a measurable desirability. Desirability could be a combination of factors including, but not limited to, building costs, labor turnover, transportation costs, raw material costs, operation costs, location specific exchange traded fund prices and other location specific data.

### Exemplary Computer Architecture for Implementation of Systems and Methods

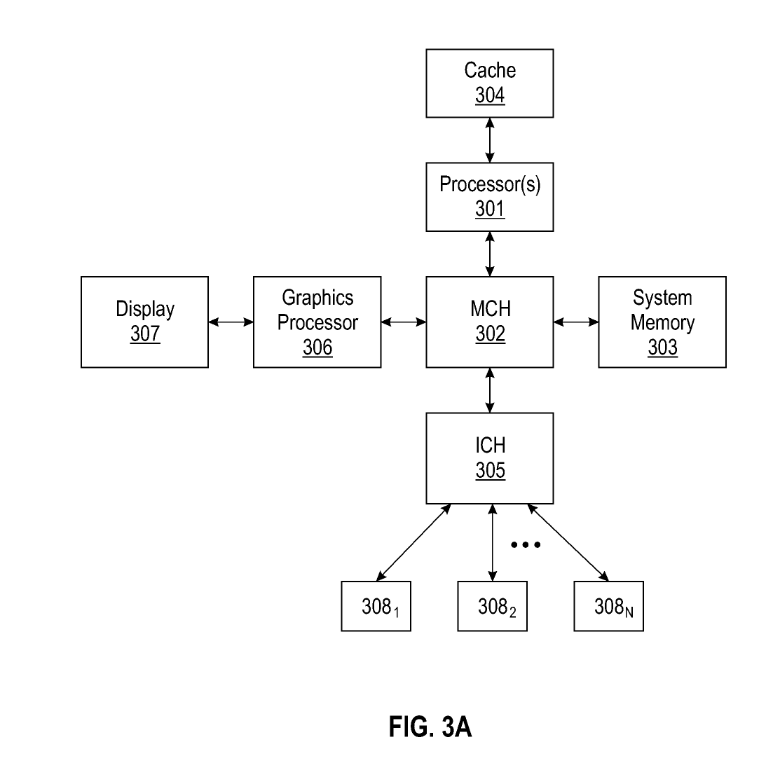

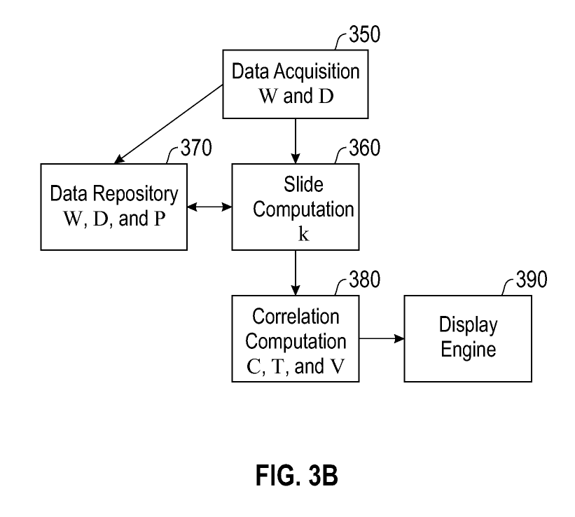

FIGS. 3A and 3B illustrate an example of computer architecture for implementing the system and methods illustrated in FIGS. 1-2 and described above. The exemplary computing system of FIG. 3A includes: 1) one or more processors 301; 2) a memory control hub (MCH) 302; 3) a system memory 303 (of which different types exist such as DDR RAM, EDO RAM, etc,); 4) a cache 304; 5) an I/O control hub (ICH) 305; 6) a graphics processor 306; 7) a display/screen 307 (of which different types exist such as Cathode Ray Tube (CRT), Thin Film Transistor (TFT), Liquid Crystal Display (LCD), DPL, etc.); and/or 8) one or more I/O devices 308.

The one or more processors 301 execute instructions in order to perform whatever software routines the computing system implements. The instructions frequently involve some sort of operation performed upon data. Both data and instructions are stored in system memory 303 and cache 304. Cache 304 is typically designed to have shorter latency times than system memory 303. For example, cache 304 might be integrated onto the same silicon chip(s) as the processor(s) and/or constructed with faster SRAM cells whilst system memory 303 might be constructed with slower DRAM cells. By tending to store more frequently used instructions and data in the cache 304 as opposed to the system memory 303, the overall performance efficiency of the computing system improves.

System memory 303 is deliberately made available to other components within the computing system. For example, the data received from various interfaces to the computing system (e.g., keyboard and mouse, printer port, LAN port, modem port, etc.) or retrieved from an internal storage element of the computing system (e.g., hard disk drive) are often temporarily queued into system memory 303 prior to their being operated upon by the one or more processor(s) 301 in the implementation of a software program. Similarly, data that a software program determines should be sent from the computing system to an outside entity through one of the computing system interfaces, or stored into an internal storage element, is often temporarily queued in system memory 303 prior to its being transmitted or stored.

The ICH 305 is responsible for ensuring that such data is properly passed between the system memory 303 and its appropriate corresponding computing system interface (and internal storage device if the computing system is so designed). The MCH 302 is responsible for managing the various contending requests for system memory 303 access amongst the processor(s) 301, interfaces and internal storage elements that may proximately arise in time with respect to one another.

One or more I/O devices 308 are also implemented in a typical computing system. I/O devices generally are responsible for transferring data to and/or from the computing system (e.g., a networking adapter); or, for large-scale non-volatile storage within the computing system (e.g., hard disk drive). ICH 305 has bi-directional point-to-point links between itself and the observed I/O devices 308.

Referring back to FIGS. 1-2, modules of the different embodiments of the described system may include software, hardware, firmware, or any combination thereof. The modules may be software programs available to the public or special or general-purpose processors running proprietary or public software. The software may also be specialized programs written specifically for signature creation and organization and recompilation management. For example, storage of the system may include, but is not limited to, hardware (such as floppy diskettes, optical disks, CD-ROMs, and magneto-optical disks, ROMs, RAMs, EPROMs, EEPROMs, flash, magnetic or optical cards, propagation media or other type of media/machine-readable medium), software (such as instructions to require storage of information on a hardware storage unit, or any combination thereof.

In addition, elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, flash, magnetic or optical cards, propagation media or other type of media/machine-readable medium suitable for storing electronic instructions.

For the exemplary methods illustrated in FIGS. 1 and 2, embodiments of the invention may include the various processes as set forth above. The processes may be embodied in machine-executable instructions which cause a general-purpose or special-purpose processor to perform certain steps. Alternatively, these processes may be performed by specific hardware components that contain hardwired logic for performing the processes, or by any combination of programmed computer components and custom hardware components.

For the exemplary system illustrated in FIGS. 1-2, embodiments of the invention may include the various modules as set forth. Each module may be implemented in hardware, software, firmware, or a combination thereof. The modules may be connected in different order and/or connect to other modules. Not all modules may be needed, or other modules may be included in implementing embodiments of the invention.

FIG. 3B is a block diagram of an example overall system architecture for implementing the embodiments seen in FIGS. 1-2. For example, Block 350 shows data acquisition of Normalized Weight W and desirability D. Block 360 shows slide computation k. Block 370 shows the data repository for W, D and P, where P, as is discussed above, is the weighted average normalized desirability. As seen in FIG. 3B, information from the data repository 370 can be communicated between Blocks 360 and 370. Block 380 shows the correlation computations of C, T and V, where, as discussed above, C is the measure of the correlation between the desirability of an asset a and P, T is the a measure of the trend of C and V is the diversification of the portfolio of assets, (which is the square of the portfolio weighted average of the correlations C). As shown in Block 390, the Display Engine could be any of the displays display/screen 307 shown in FIG. 3A, of which different types exist such as Cathode Ray Tube (CRT), Thin Film Transistor (TFT), Liquid Crystal Display (LCD), DPL, etc.).

Embodiments of the invention do not require all of the various processes presented, and it may be conceived by one skilled in the art as to how to practice the embodiments of the invention without specific processes presented or with extra processes not presented.

### GENERAL

The foregoing description of the embodiments of the invention has been presented only for the purpose of illustration and description and is not intended to be exhaustive or to limit the invention to the precise forms disclosed. Numerous modifications and adaptations are apparent to those skilled in the art without departing from the spirit and scope of the invention.

What is claimed is:

1) A method for displaying portfolio risk, comprising:
receiving a time series corresponding to a weight and a desirability of each of an asset in a portfolio;
maintaining the time series corresponding to the weight and the desirability of each of the assets in the portfolio;
maintaining a standard time series for comparison with the time series corresponding to the weight and the desirability of each of the assets in the portfolio;
displaying, for each asset in the portfolio, a quantity based on desirability versus a quantity based on the correlation between desirability and the standard time series over two specified windows of time; and,
displaying trend information based on moving two specified windows of time from the past to the point where at least one window is the most current window.

2) The method of claim 1, wherein the two specific windows of time are selected from the group consisting of desirability and the standard time series.

3) The method of claim 1, wherein the standard time series for comparison is a weighted average of the normalized desirability time series for assets in the portfolio.

4) The method of claim 1, wherein the two specified windows of time are both the most current window of time available.

5) The method of claim 1, wherein only one of the two windows of time is the most current window of time available, the other window being delayed.

6) A computer program product comprising a computer useable storage medium to store a computer readable program, wherein the computer readable program, when executed on a computer, causes the computer to perform operations for displaying portfolio risk comprising:
receiving a time series corresponding to a weight and a desirability of each of an asset in a portfolio;
maintaining the time series corresponding to the weight and the desirability of each of the assets in the portfolio;
maintaining a standard time series for comparison with the time series corresponding to the weight and the desirability of each of the assets in the portfolio;
displaying, for each asset in the portfolio, a quantity based on desirability versus a quantity based on the correlation between desirability and the standard time series over two specified windows of time; and,
displaying trend information based on moving two specified windows of time from the past to the point where at least one window is the most current window.

7) The computer program product of claim 6, wherein the two specific windows of time are selected from the group consisting of desirability and the standard time series.

8) The computer program product of claim 6, in which the standard time series for comparison is a weighted average of the normalized desirability time series for assets in the portfolio.

9) The computer program product of claim 6, wherein the two specified windows of time are both the most current window of time available.

10) The computer program product of claim 6, wherein only one of the two windows of time is the most current window of time available, the other window being delayed.

11) A system for displaying portfolio risk, comprising:
a first module configured to:
receive a time series corresponding to a weight and a desirability of each of an asset in a portfolio;
maintain the time series corresponding to the weight and the desirability of each of the assets in the portfolio; and,
maintain a standard time series for comparison with the time series corresponding to the weight and the desirability of each of the assets in the portfolio;
a display module coupled to the first module an configured to:
display, for each asset in the portfolio, a quantity based on desirability versus a quantity based on the correlation between desirability and the standard time series over two specified windows of time; and,
display trend information based on moving two specified windows of time from the past to the point where at least one window is the most current window.

12) The system of claim 11, wherein the two specific windows of time are selected from the group consisting of desirability and the standard time series.

13) The system of claim 11, wherein the standard time series for comparison is a weighted average of the normalized desirability time series for assets in the portfolio.

14) The system of claim 11, wherein the two specified windows of time are both the most current window of time available.

15) The system of claim 11, wherein only one of the two windows of time is the most current window of time available, the other window being delayed.
